(19) United States
(12) Patent Application Publication
(10) Pub. No.: US 2020/0394085 A1
(43) Pub. Date: Dec. 17, 2020

(54) SMART CONTRACT INFORMATION REDIRECT TO UPDATED VERSION OF SMART CONTRACT

(71) Applicant: Microsoft Technology Licensing, LLC, Redmond, WA (US)

(72) Inventor: Marc Edward MERCURI, Bothell, WA (US)

(21) Appl. No.: 16/442,836

(22) Filed: Jun. 17, 2019

(51) Int. Cl. G06F 9/54; G06F 16/23

(52) U.S. Cl. CPC G06F 9/542; G06F 16/2379

(57) ABSTRACT

The disclosed technology is generally directed to blockchain technology. In one example of the technology, a call to a first smart contract function of a first smart contract is received from a requestor. A redirection policy status of the first smart contract function is evaluated. Responsive to an evaluation that a redirection policy status of the first smart contract function is a status indicating “redirect,” a first event is communicated to the requestor, such that the first event includes an indication that an updated version of the first smart contract exists, such that the first event includes metadata, and such that the metadata includes information associated with requesting a function call to the updated version of the first smart contract.

### BACKGROUND

Blockchain systems have been proposed for a variety of application scenarios, including applications in the financial industry, health care, IoT, and so forth. For example, the Bitcoin system was developed to allow electronic cash to be transferred directly from one party to another without going through a financial institution. Blockchain systems have also been used for the implementation of smart contracts to automate transactions on the blockchain, including triggering clauses upon specified conditions being met.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to blockchain technology. In one example of the technology, a call to a first smart contract function of a first smart contract is received from a requestor. In some examples, a redirection policy status of the first smart contract function is evaluated. In some examples, responsive to an evaluation that a redirection policy status of the first smart contract function is a status indicating “redirect,” a first event is communicated to the requestor, such that the first event includes an indication that an updated version of the first smart contract exists, such that the first event includes metadata, and such that the metadata includes information associated with requesting a function call to the updated version of the first smart contract.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a system; and

FIG. 4 is a diagram illustrating an example process for information redirects to an updated version of a smart contract, in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on”, and includes the option of being based on additional factors, some of which may not be described herein. As another example, the term “via” is not exclusive, and is equivalent to the term “via, at least in part”, and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof.

Briefly stated, the disclosed technology is generally directed to blockchain technology. In one example of the technology, a call to a first smart contract function of a first smart contract is received from a requestor. In some examples, a redirection policy status of the first smart contract function is evaluated. In some examples, responsive to an evaluation that a redirection policy status of the first smart contract function is a status indicating “redirect,” a first event is communicated to the requestor, such that the first event includes an indication that an updated version of the first smart contract exists, such that the first event includes metadata, and such that the metadata includes information associated with requesting a function call to the updated version of the first smart contract.

In some examples, a smart contract includes computer-executable code that makes use of a distributed ledger to digitally execute one or more agreements and/or transactions between parties. The smart contract may perform, facilitate, verify, and/or enforce the agreements and/or transactions of the smart contract. The smart contract may be entirely on a blockchain, or the smart contract may include some off-chain logic with the state of the smart contract being tracked by a blockchain or other distributed ledger. A smart contract may have one or more associated defined functions that are used to interact with the smart contract. The smart contract may be interacted with by calling one of the defined functions of the smart contract.

There may be various reasons to alter a smart contract, including, as one example, new regulations governing the subject matter of a smart contract. For example, new regulation could require that new additional information be collected from mortgage applicants. In some examples, because a blockchain is immutable, when a smart contract changes, it may be desirable or necessary to create a new version of the smart contract.

A smart contract may be created with a redirection policy. In some examples, upon creation of a new smart contract, by default, each function of the smart contract has a redirection policy status indicating that the function is allowed. In some examples, a function that has the “allowed” status functions in a normal matter. The redirection policy may have one or more functions that an authorized user may use to alter the redirection policy status of one or more, including possibly all, of the functions of the smart contract. In some examples, the redirection policy status for each function can be any of the following three possible statuses: a status indicating that the function is “allowed” as discussed above, a status indicating that the function is “disallowed,” or a status indicating “redirect” for the function.

As discussed above, in some examples, if a function is called and the redirection policy status indicates “allowed,” then the function operates in the normal matter. In some examples, responsive to a function having a redirection policy indicates “redirect” being called, the function sends back the requestor an indication that there is an updated version of the smart contract, and sends the requestor metadata about the updated version of the smart contract, so that the requestor can make the request on the updated version of the smart contract.

### Illustrative Devices/Operating Environments

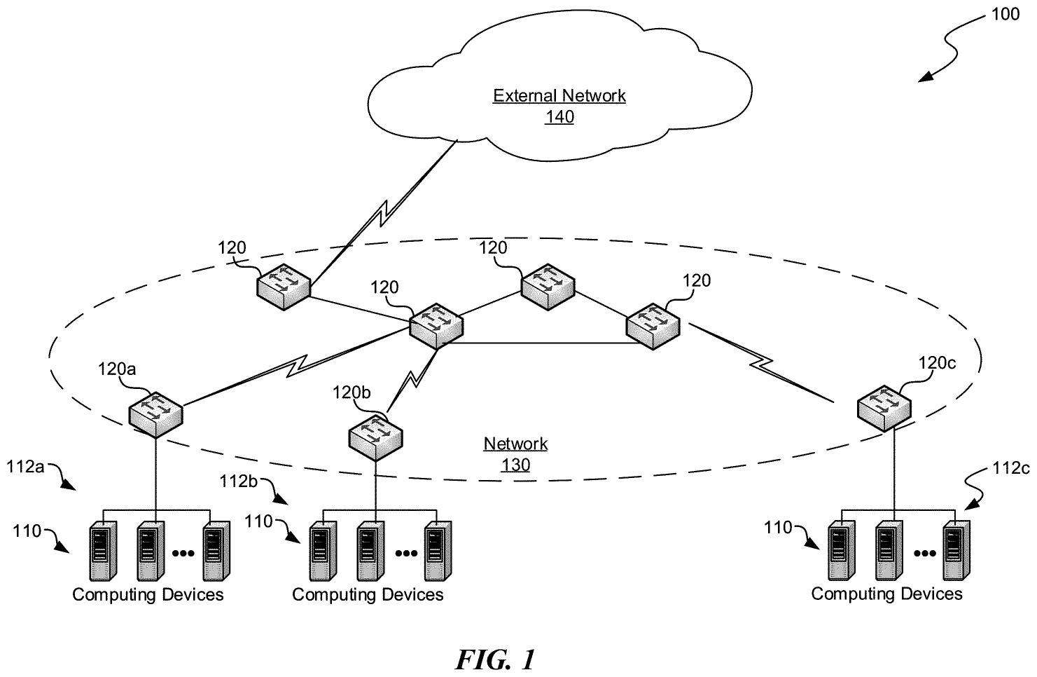

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices 110 shown in FIG. 1 may be in various locations, including on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices 110 can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices no may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

Various computing devices and nodes in environment 100 may include one or computing device and network nodes included in one or more networks with associated distributed ledgers, such as one or more blockchain networks, and may further include one or more computing device outside of the blockchain networks that communicate with one or more of the blockchain networks.

### Illustrative Computing Device

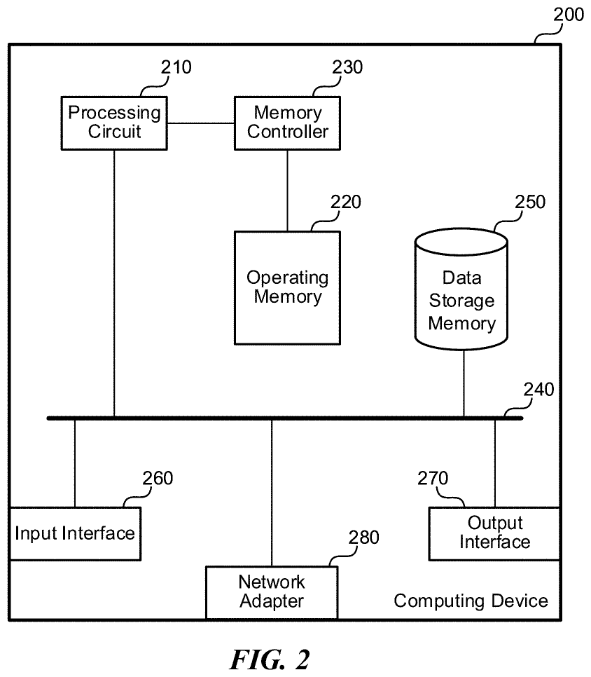

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, embedded device, programmable logic controller (PLC), or a smartphone. Likewise, computing device 200 may also be server device such as an application server computer, a virtual computing host computer, or a file server computer, e.g., computing device 200 may be an example of computing device 110 or network node 120 of FIG. 1. Likewise, computer device 200 may be an example any of the devices, nodes, members, or other entities illustrated in or referred to in various figures, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process.

Operating memory 220 may include 4th generation double data rate (DDR4) memory, 3rd generation double data rate (DDR3) memory, other dynamic random access memory (DRAM), High Bandwidth Memory (HBM), Hybrid Memory Cube memory, 3D-stacked memory, static random access memory (SRAM), or other memory, and such memory may comprise one or more memory circuits integrated onto a DIMM, SIMM, SODIMM, or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although FIG. 2 illustrates bus 240 as a single passive bus, other configurations, such as a collection of buses, a collection of point to point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims, whether used in the singular form or the plural form, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long Term Evolution (LTE) adapter, or a 5G adapter.

Although computing device 200 is illustrated with certain components configured in a particular arrangement, these components and arrangements are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

Some examples of computing device 200 include at least one memory (e.g., operating memory 220) adapted to store run-time data and at least one processor (e.g., processing unit 210) that is respectively adapted to execute processor-executable code that, in response to execution, enables computing device 200 to perform actions.

### Illustrative System

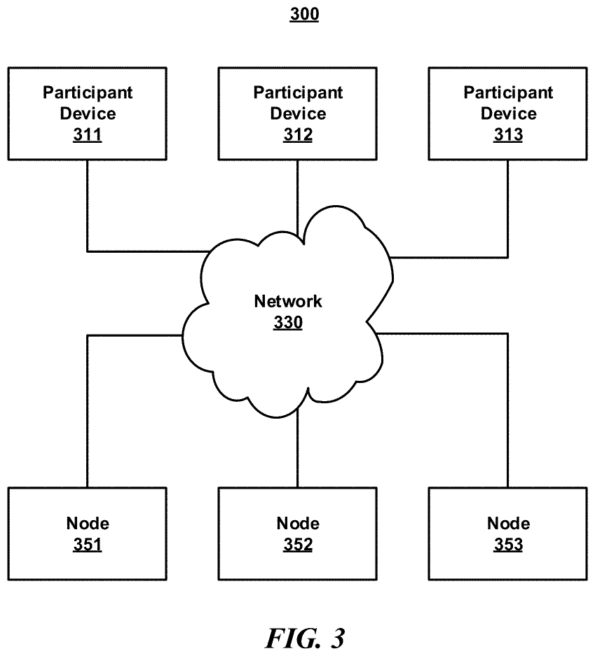

FIG. 3 is a block diagram illustrating an example of a system (300) for a network that includes at least a portion of a blockchain network and devices in communication with the blockchain network. System 300 may include network 330, blockchain nodes 351-353, and participant devices 311-313.

Each of the participant devices 311-313, and/or blockchain nodes 351-353 may include examples of computing device 200 of FIG. 2. FIG. 3 and the corresponding description of FIG. 3 in the specification illustrates an example system for illustrative purposes that does not limit the scope of the disclosure.

Network 330 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 330 may include various other networks such as one or more networks using local network protocols such as 6LoWPAN, ZigBee, or the like. In essence, network 330 includes any communication method by which information may travel between blockchain nodes 351-353 and participant devices 311-313. Although each device or service is shown connected as connected to network 330, that does not mean that each device communicates with each other device shown. In some examples, some devices/services shown only communicate with some other devices/services shown via one or more intermediary devices. Also, although network 330 is illustrated as one network, in some examples, network 330 may instead include multiple networks that may or may not be connected with each other, with some of the devices shown communicating with each other through one network of the multiple networks and other of the devices shown communicating with each other with a different network of the multiple networks.

In some examples, participant devices 311-313 are devices used by participants to communicate over network 330, such as to request a transaction. Such participants may be, for example, any suitable device requesting a transaction on a public blockchain network, such as a wallet application on a network device requesting a transaction on a public blockchain network; a device requesting the initiating of a smart contract or interacting with a smart contract on a blockchain network; a non-member participant device of a consortium blockchain network requesting a transaction; an off-chain device running an off-chain process that interacts with smart contracts and/or blockchain transactions in some manner, and/or the like.

In some examples, blockchain nodes 351-353 are devices that, during normal operation, validate and process submitted blockchain transactions, and execute chaincode. A blockchain node that is creating new blocks is referred to as a miner. A blockchain node may also perform one or more actions associated with one or more smart contracts, including tracking the state of one or more smart contracts on a blockchain or other distributed ledger.

Although the discussion above primarily concerns a blockchain network, in some examples, the network may instead may a distributed ledger network that is not a blockchain network.

System 300 may include more or less devices than illustrated in FIG. 3, which is shown by way of example only.

System 300 may include one or smart contracts. Each smart contract may have an associated distributed ledger. In some examples, the smart contract executes from code on the distributed ledger, and the state of the smart contract is tracked via the distributed ledger. In some examples, some aspects of the smart contract may be executed off-chain, with the state of the smart contract still being tracked via the distributed ledger. Each smart contract may have one or more associated functions, with the smart contract being interacted with via the functions of the smart contract. In some examples, a requestor, such one of the participant device 311-313, may call a function, and a node, such as one of the blockchain nodes 351-353, may respond to the function call.

A smart contract may be created with a redirection policy. Upon creation of a new smart contract, by default, each function of the smart contract has a redirection policy status indicating that the function is allowed. A function that has the “allowed” status functions in a normal matter. The redirection policy may have one or more functions that an authorized user may use to alter the redirection policy status of one or more, including possibly all, of the functions of the smart contract. In some examples, the possible redirection statuses for each function may include at least “allowed” and “redirect.” In some examples, the redirection policy status for each function can be any of the following three possible statuses: a status indicating that the function is “allowed” as discussed above, a status indicating that the function is “disallowed,” or a status indicating “redirect” for the function.

As discussed above, in some examples, if a function is called and the redirection policy status indicates “allowed,” then the function operates in the normal matter. In some examples, responsive to a function being called for which the redirection policy status of the function indicates “disallowed,” the function may then respond to the requestor with an error or the like.

In some examples, responsive to a function having a redirection policy indicates “redirect” being called, the function sends back the requestor an indication that there is an updated version of the smart contract, and sends the requestor metadata about the updated version of the smart contract, so that the requestor can make the request on the updated version of the smart contract.

Initially, the redirection policy may have one or more function(s) that enable a redirect to be possible; typically, the redirection policy function(s) would not be used until and unless a new version of the smart contract is created. In some examples, the default redirect policy status of each function of the smart contract indicates “allowed,” and an authorized user would be able to use the redirection policy function(s) to change the redirection policy status of one or more of the functions of the smart contract. If a new version of the smart contract is created, the redirection policy may be used to alter the redirection policy state or some or all of the functions of the smart contract, so that function calls to the smart contract can be redirected to the new version of the smart contract when appropriate. The redirection policy function(s) may also enable the metadata associated with the new smart contract be provided for each function for which the redirection polity status is indicated as “redirect,” so that the metadata can be provided to a requestor of the function.

It may be desirable to have certain functions on the earlier smart contract still be functional on the original smart contract, even though the original smart contract is no longer the current version of the smart contract. Thus, certain functions on the smart contract might remain allowed even though an updated version of the smart contract exists. There may be functions that should be completely disallowed, and not even redirected, at least for certain users, such as, for example, a party to the earlier version of the smart contract that is not a party to the updated version of the contract. Accordingly, the disallowed status may be assigned to a function in some cases. For some functions, when an updated version of a smart contract exists, it may be desired to redirect a caller of the function to the updated version of the contract, and accordingly the function may be assigned a redirect status. As discussed above, the status of the function may vary by user, so that the redirection policy status of a particular function may differ depending on the identity of the user. The status may also vary based on a variety of other conditions besides the identify of the requesting user.

If a function has a redirection policy status that indicates “redirect,” in some examples, in response to a function call to the function, the network node handling the function call sends back to the requestor an event. The event may include an indication that there is an updated version of the smart contract, and the event may also include metadata. The metadata may include information about the updated version of the smart contract, so that the requestor can make the request on the updated version of the smart contract. The metadata may include information as to how the requestor may make the function call on the updated smart contract, such as information about the location of the updated smart contract, and the metadata may further include a function signature—the function signature may include new information about the function in case the function has changed on the updated smart contract. The updated smart contract may be on the same distributed ledger as the called function, or a different distributed ledger than the called function.

In some examples, the metadata may include (1) a common name of the ledger, (2) the ledger type of the ledger, (3) the ledger endpoint, (4) the ledger contract identifier, and (5) the function signature, where the ledger refers to the distributed ledger of the updated smart contract. If the ledger is the same as the smart contract being called, then in some examples only (4) the ledger contract identifier and (5) the function signature are included. If the function name and parameters are unchanged, then the function signature might be excluded in some examples.

In some examples, the common name refers to the common name, if any, of the distributed ledger of the new smart contract. In some examples, the ledger type refers to the type of ledger of the ledger of the updated smart contract. For instance, the ledger type could be Corda, Ethereum, or another suitable ledger type. In some examples, the ledger endpoint refers to the location of the ledger, or more specifically the means may which the request may access the ledger, which may vary according to the ledger type. For instance, in some examples, the ledger endpoint may be real-time transport (RTP) endpoint of the ledger, or the like. In some examples, the ledger endpoint may be a web address or the like.

In some examples, the ledger contract identifier refers to the means for identifying the updated smart contract on the ledger. The ledger contract identifier may be an address of the updated smart contract, an identifier of the updated smart contract, or other suitable means of locating/identifying the updated smart contract on the ledger.

The function signature may include the old function name, the new function name, the parameters of the old function, and the parameters of the new function, for the function called by the requestor (the “old function” refers to the function being called and the “new function” refers to corresponding function on the updated version of the smart contract). The function name and/or function parameters may have changed in the updated smart contract. By providing the function signature, in some examples, the requestor can properly call the function in the updated smart contract in spite of changes that may have occurred in the name and/or parameters of the function.

### Illustrative Process

For clarity, the processes described herein are described in terms of operations performed in particular sequences by particular devices or components of a system. However, it is noted that other processes are not limited to the stated sequences, devices, or components. For example, certain acts may be performed in different sequences, in parallel, omitted, or may be supplemented by additional acts or features, whether or not such sequences, parallelisms, acts, or features are described herein. Likewise, any of the technology described in this disclosure may be incorporated into the described processes or other processes, whether or not that technology is specifically described in conjunction with a process. The disclosed processes may also be performed on or by other devices, components, or systems, whether or not such devices, components, or systems are described herein. These processes may also be embodied in a variety of ways. For example, they may be embodied on an article of manufacture, e.g., as processor-readable instructions stored in a processor-readable storage medium or be performed as a computer-implemented process. As an alternate example, these processes may be encoded as processor-executable instructions and transmitted via a communications medium.

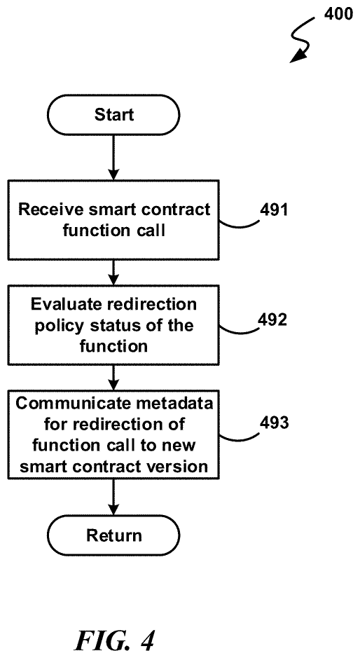

FIG. 4 is a diagram illustrating an example dataflow for a process (490) for a blockchain system. In some examples, the process of FIG. 4 is performed by one or more network nodes having an associated distributed ledger. In the illustrated example, step 491 occurs first. At step 491, in some examples, a call to a first smart contract function of a first smart contract is received from a requestor. As shown, step 492 occurs next in some examples. At step 492, in some examples, a redirection policy status of the first smart contract function is evaluated.

As shown, step 493 occurs next in some examples. At step 493, in some examples, responsive to an evaluation that a redirection policy status of the first smart contract function is a status indicating “redirect,” a first event is communicated to the requestor, such that the first event includes an indication that an updated version of the first smart contract exists, such that the first event includes metadata, and such that the metadata includes information associated with requesting a function call to the updated version of the first smart contract. The processing may then proceed to a return block, where other processing is resumed.

### Conclusion

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
a device including at least one memory adapted to store run-time data for the device, and at least one processor that is adapted to execute processor-executable code that, in response to execution, enables the device to perform actions, including:
receiving, from a requestor, a call to a first smart contract function of a first smart contract;
evaluating a redirection policy status of the first smart contract function; and
responsive to an evaluation that a redirection policy status of the first smart contract function is a status indicating “redirect,” communicating a first event to the requestor, such that the first event includes an indication that an updated version of the first smart contract exists, such that the first event includes metadata, and such that the metadata includes information associated with requesting a function call to the updated version of the first smart contract.

2. The apparatus of claim 1, wherein the metadata includes a ledger contract identifier.

3. The apparatus of claim 1, wherein the metadata includes a ledger endpoint of a distributed ledger associated with the updated version of the first smart contract.

4. The apparatus of claim 1, wherein the metadata includes a ledger type of a distributed ledger associated with the updated version of the first smart contract.

5. The apparatus of claim 1, wherein the metadata includes a common name of a distributed ledger associated with the updated version of the first smart contract.

6. The apparatus of claim 1, wherein the metadata includes a function signature.

7. The apparatus of claim 6, wherein the function signature includes at least a name of a function on the updated version of the first smart contract, and parameters of the function on the updated version of the first smart contract.

8. The apparatus of claim 1, the actions further including:
enabling a user to set a redirection policy status of each function of a plurality of functions of the first smart contract, wherein the plurality of functions of the first smart contract includes the first smart contract function, and wherein, for each function of the plurality of functions of the first smart contract, the possible redirection policy statuses of the function include: a status indicating “allowed,” and the status indicating “redirect.”

9. The apparatus of claim 8, wherein, for each function of the plurality of functions of the first smart contract, the possible redirection policy statuses of the function also include: a status indicating “disallowed.”

10. A method, comprising:
receiving a communication, wherein the communication includes a call from a requestor to a first smart contract function of a first smart contract;
determining a redirection policy status associated with the first smart contract function; and
via at least one processor, responsive to an evaluation that a redirection policy status of the first smart contract function is a status indicating “redirect,” causing a first event to be communicated to the requestor, such that the first event includes an indication that an updated version of the first smart contract exists, such that the first event includes metadata, and such that the metadata includes information associated with requesting a function call to the updated version of the first smart contract.

11. The method of claim 10, wherein the metadata includes a ledger contract identifier.

12. The method of claim 10, wherein the metadata includes a ledger endpoint of a distributed ledger associated with the updated version of the first smart contract.

13. The method of claim 10, wherein the metadata includes a ledger type of a distributed ledger associated with the updated version of the first smart contract.

14. The method of claim 10, wherein the metadata includes a function signature.

15. The method of claim 10, further comprising:
enabling a user to set a redirection policy status of each function of a plurality of functions of the first smart contract, wherein the plurality of functions of the first smart contract includes the first smart contract function, and wherein, for each function of the plurality of functions of the first smart contract, the possible redirection policy statuses of the function include: a status indicating “allowed,” and the status indicating “redirect.”

16. A processor-readable storage medium, having stored thereon process-executable code that, upon execution by at least one processor, enables actions, comprising:
responsive to a call to a first smart contract function of a first smart contract from a requestor, evaluating a status of the first smart contract function; and
responsive to an evaluation that a status of the first smart contract function is a status indicating “redirect,” communicating an indication that an updated version of the first smart contract exists, and further communicating metadata, such that the metadata includes information associated with requesting a function call to the updated version of the first smart contract.

17. The processor-readable storage medium of claim 16, wherein the metadata includes a ledger contract identifier.

18. The processor-readable storage medium of claim 16, wherein the metadata includes a ledger endpoint of a distributed ledger associated with the updated version of the first smart contract.

19. The processor-readable storage medium of claim 16, wherein the metadata includes a ledger type of a distributed ledger associated with the updated version of the first smart contract.

20. The processor-readable storage medium of claim 16, the actions further comprising:
enabling a user to set a redirection policy status of each function of a plurality of functions of the first smart contract, wherein the plurality of functions of the first smart contract includes the first smart contract function, and wherein, for each function of the plurality of functions of the first smart contract, the possible redirection policy statuses of the function include: a status indicating “allowed,” and the status indicating “redirect.”
